(19) United States
(12) Patent Application Publication
(10) Pub. No.: US 2015/0012879 A1
(43) Pub. Date: Jan. 8, 2015

(54) DEVICE AND METHOD FOR MOVING DISPLAY WINDOW ON SCREEN

(71) Applicant: Samsung Electronics Co.Ltd, Suwon-si, Gyeonggi-do (KR)

(72) Inventors: Eun-young Kim, Yongin-si (KR); Kang-tae Kim, Yongin-si (KR); Duck-hyun Kim, Suwon-si (KR); Chul-joo Kim, Suwon-si (KR); Kwang-won Sun, Suwon-si (KR); Jae-yeol Lee, Suwon-si (KR)

(21) Appl. No.: 14/380,865

(22) PCT Filed: Feb. 20, 2013
(86) PCT No.: PCT/KR2013/001336

§ 371 Date: Aug. 25, 2014

(30) Foreign Application Priority Data
Feb. 24, 2012 (KR) 10-2012-0019179
Aug. 30, 2012 (KR) 10-2012-0095903

(51) Int. Cl. G06F 3/0481; G06F 3/0484

(52) U.S. Cl. CPC G06F 3/0481; G06F 3/0484
USPC 715/788; 715/790

(57) ABSTRACT

A method of moving a display window on a screen is provided. The method includes displaying a key input window on a part of a screen, and moving a first display window corresponding to the key input window as the key input window is displayed, wherein the first display window is moved as the key input window overlaps at least part of the first display window.

### CROSS-REFERENCE TO RELATED APPLICATION(S)

This application is a U.S. National Stage application under 35 U.S.C. §371 of an International application filed on Feb. 20, 2013, and assigned application number PCT/KR2013/001336, which claimed the benefit of a Korean patent application filed on Feb. 24, 2012, in the Korean Intellectual Property Office and assigned Serial number 10-2012-0019179, and a Korean patent application filed on Aug. 30, 2012, in the Korean Intellectual Property Office and assigned Serial number 10-2012-0095903, the entire disclosure of each of which is hereby incorporated by reference.

### TECHNICAL FIELD

The present disclosure relates to a device and method for moving a display window on a screen. More particularly, the present disclosure relates to a device and method for moving a predetermined display window on a screen in response to a display of a key input window.

### BACKGROUND ART

Generally, a touch screen is an electronic device that can be controlled by a user by touching it with one or more fingers. The touch screen may be made by adding a touch panel to a display, and is utilized in various applications due to its convenience of use.

Further, as a central processing unit and memory embedded in a device including a touch screen have been continuously developed, the device can play a high-definition video file while a display window for various applications is being displayed on the touch screen of the device.

As such, when a user tries to input a key by using the touch screen, the display window and the key input window are displayed together on one area of the touch screen, and the display window for a key input is covered by the key input window.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a device and method for moving a display window on a screen, whereby the display window is moved while being overlapped with a key input window for a key input when the key input window is displayed on the screen.

Another aspect of the present disclosure is also to provide a device and a method for moving a display window on a screen, whereby the display window to be moved is selected as a key input window is being displayed, and the selected display window is changed, moved, and arranged.

Other aspects, advantages, and salient features of the disclosure will become apparent to those skilled in the art from the following detailed description, which, taken in conjunction with the annexed drawings, discloses various embodiments of the present disclosure.

### DESCRIPTION OF DRAWINGS

The above and other aspects, features, and advantages of certain embodiments of the present disclosure will be more apparent from the following description taken in conjunction with the accompanying drawings, in which:

FIG. 1 illustrates a plurality of display windows which are overlapped and displayed on a touch screen according to an embodiment of the present disclosure;

FIG. 2 is a view illustrating a detailed configuration of a device for moving a display window on a screen according to an embodiment of the present disclosure;

FIG. 3 is a detailed flowchart illustrating a method of moving a display window on a screen according to an embodiment of the present disclosure;

FIG. 4 is a detailed flowchart illustrating a method of moving a display window moved when a key input window is removed according to an embodiment of the present disclosure;

FIG. 5 illustrates an example of movement of a first display window according to an embodiment of the present disclosure;

FIG. 6 illustrates an example of movement of a first display window according to another embodiment of the present disclosure;

FIG. 7 illustrates an example of reduction and movement of a first display window according to an embodiment of the present disclosure;

FIG. 8 illustrates an example of movement of a first display movement along with another display window according to an embodiment of the present disclosure;

FIG. 9 illustrates an example of arrangement and movement of display windows other than the first display window according to another embodiment of the present disclosure;

FIG. 10 illustrates an example in which the thickness of the border of a display window is changed and then displayed according to an embodiment of the present disclosure; and

FIG. 11 illustrates an example in which a display window which has been moved according to a display of a key input window is reduced as a device is rotated according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

According to an aspect of the present disclosure, there is provided a method of moving a display window on a screen, including displaying a key input window on a part of a screen and moving a first display window corresponding to the key input window as the key input window being displayed, wherein the first display window is moved as the key input window overlaps at least part of the first display window and displayed.

According to another aspect of the present disclosure, a device for moving a display window on a screen is provided. The device includes a display unit configured to display a key input window on a part of the screen, and a movement location determination unit configured to determine a movement location of the first display window corresponding to the key input window as the key input window is displayed, wherein the display unit moves the first display window based on the determined movement location, and moves the first display window as the key input window overlaps at least part of the first display window and displayed.

According to another aspect of the present disclosure, a non-transitory computer-readable storage medium is provided. The storage medium has recorded thereon a program for executing the method of the first aspect in a computer.

The various embodiments of the present disclosure will be described in detail with reference to the attached drawings so that those skilled in the art can execute the various embodiments. However, the present disclosure may be implemented in various different forms and is not limited to the various embodiments described here. Further, portions which are not related with the description have been omitted for clarity of description, and the same symbols have been used for the same components throughout the specification.

In this specification, the term “connected” refers to both “directly connected” and “electrically connected”. Further, “including” a certain component does not exclude the possibility of including other components unless disclosed otherwise.

Hereinafter, the present disclosure will be described in detail with reference to the attached drawings.

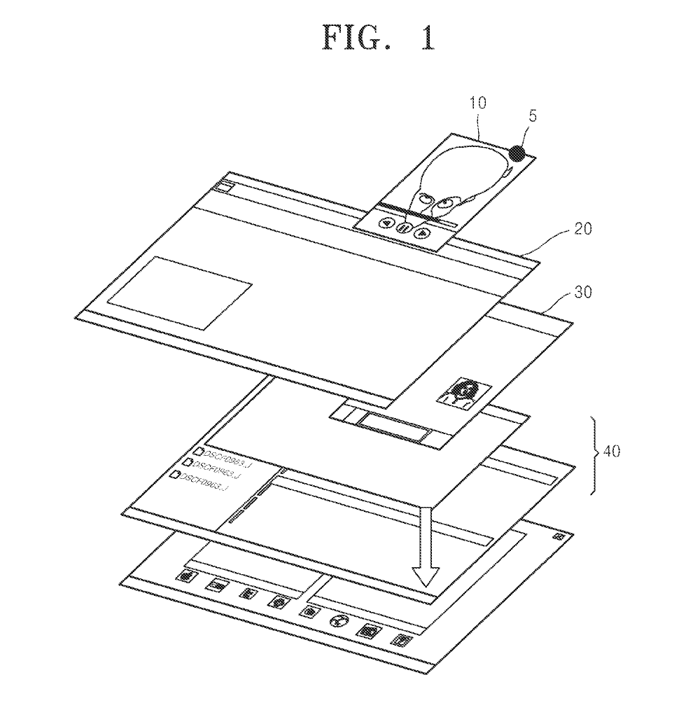

FIG. 1 illustrates a plurality of display windows which are overlapped and displayed on a touch screen according to an embodiment of the present disclosure.

As illustrated in FIG. 1, a plurality of display windows 10, 20, 30, and 40 may be overlapped and displayed on a touch screen according to an embodiment of the present disclosure. A pin-up display window 10 is a window set to be displayed on the uppermost part of the screen, and may always be displayed on the uppermost part of the screen when displayed with another display window on the screen. Further, a separate icon 5 may be also displayed in a preset area of the pin-up display window 10. For example, a pin-shaped icon may be displayed on the pin-up display window 10 as if the icon were inserted into the pin-up display window 10.

A whole screen mode display window 20 is a window set to be displayed on the entire screen, and may be displayed on the screen to have the same size as the screen.

A partial screen mode display window 30 is a window set to be displayed on a part of the screen, and may be appropriate for an application which supports a window having a size smaller than the full screen size. Further, the partial screen mode display window 30 may be appropriate for, for example, an application capable of redundantly displaying windows, such as an application that provides a chatting function, a memo function, etc.

Further, a free-size mode display window 40 may be a window which may be displayed on a part of the screen, and the size of which may be freely adjusted.

Further, the display windows 10, 20, 30, and 40 may be overlapped and displayed, and a predetermined window may be displayed from among the display windows 10, 20, 30 and 40 depending on the type of the application.

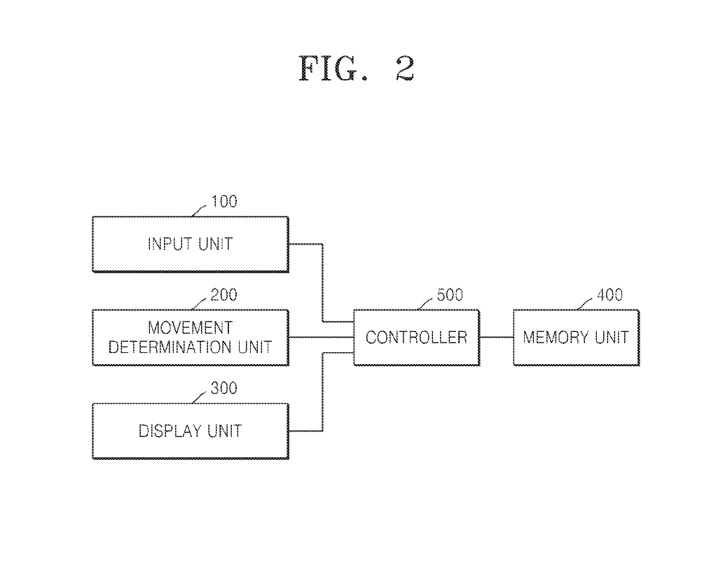

FIG. 2 is a view illustrating a detailed configuration of a device for moving a display window on a screen according to an embodiment of the present disclosure.

As illustrated in FIG. 2, a device for moving a display window on a screen according to an embodiment of the present disclosure includes an input unit 100, a movement determination unit 200, a display unit 300, a memory unit 400, and a controller 500.

The input unit 100 receives a user's input. The user may touch a preset location on the screen of the device, and the input unit 100 may receive the user's input via the user's touch. However, the present disclosure is not limited thereto, and the input unit 100 may receive the user's input through an input tool such as a keyboard, a mouse, a stylus pen, etc.

The movement determination unit 200 selects a display window to be moved on the screen of the device as a key input unit is being displayed. When the key input unit is displayed on the screen of the device, the movement determination unit 200 may select a display window to be moved from among display windows displayed on the screen of the device. The key input window may be slid from at least one of the upper, lower, right, and left sides so as to be displayed on a part of the screen, but the present disclosure is not limited to this example.

When a key input field displayed in the displayed window is selected, the movement determination unit 200 may select a display window including the selected key input field as a display window to be moved.

Specifically, when a key input field included in the first display window is selected and the key input window is overlapped with part of the first display window and displayed in the screen of the device, the movement determination unit 200 may select the first display window as a display window to be moved. Further, when the key input window is overlapped with the key input field included in the first display window and is displayed, the movement determination unit 200 may determine the first display window as a display window to be moved.

Further, the movement determination unit 200 may select a second display window without the selected key input field along with the first display window. The second display window may be a display window which does not include a key input field in which letters inputted through the key input window are displayed. For example, the movement determination unit 200 may select a pin-up display window 10 which does not include the selected key input field. Further, the movement determination unit 200 may select a partial screen mode display window 30 which does not include the selected key input field.

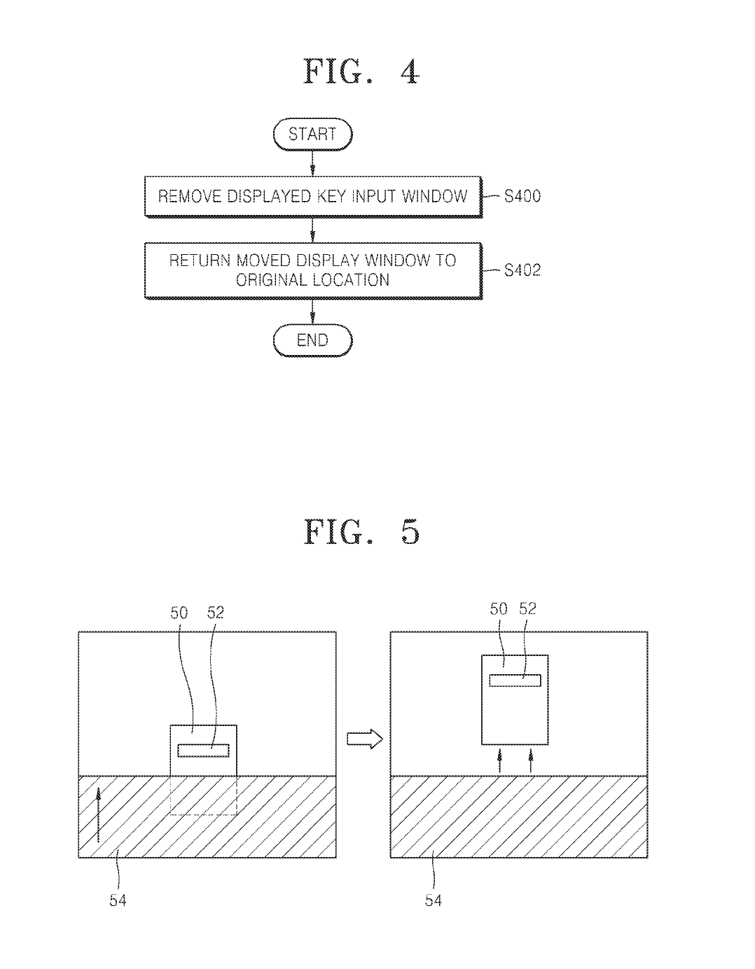

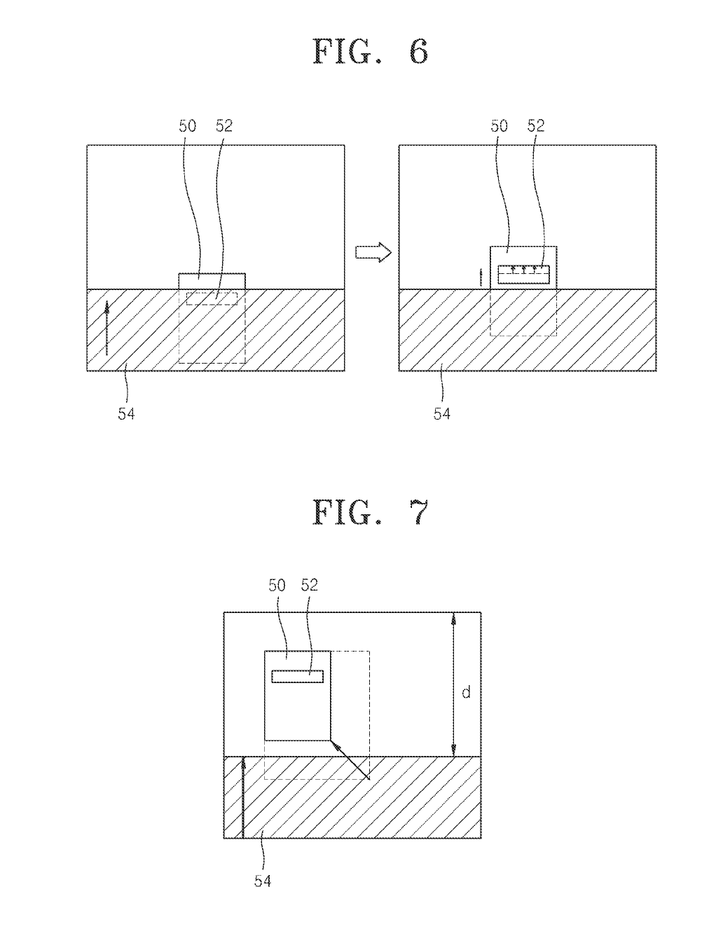

An example of selecting a display window to be moved by the movement determination unit 200 will be described in more detail below with reference to FIGS. 5 and 6.

Further, the movement determination unit 200 determines the movement location of the selected display window. The movement determination unit 200 may determine the movement location of the selected display window so that all or part of the selected display window is not overlapped with the key input window. Further, the movement determination unit 200 may determine the movement location of the selected display window so that the key input field included in the selected display window is not overlapped with the key input window, but the present disclosure is not limited to this example.

Further, when the selected display window is moved, the movement determination unit 200 may determine a ratio by which the selected display window is enlarged or reduced. The movement determination unit 200 may determine the ratio of enlargement/reduction of the selected display window based on the size of the portion which is not covered by the key input window in the screen. For example, when the key input window is displayed in the lower part of the screen, the ratio of enlargement/reduction of the selected display window may be determined based on a distance between the upper side of the key input window and the upper side of the screen, but the present disclosure is not limited to this example.

Further, after determining a plurality display windows as display windows to be moved, the movement determination unit 200 may determine how to arrange the plurality of display windows. The movement determination unit 200 may determine how to arrange the display windows based on the size of the part which is not covered by the key input window, and the size of the display window to be moved. For example, the movement determination unit 200 may decide to reduce the plurality of display windows to a predetermined size, and arrange the reduced display windows in a tiled manner so as to be moved. Further, for example, when the first display window and the second display window are selected, the movement determination unit 200 may set the first display window to be located in the central part of the screen and the second display window to be arranged in the right and left sides of the first display window.

The display unit 300 displays the display window on the screen.

The display unit 300 may display at least one of a pin-up display window 10, a whole screen mode display window 20, a partial screen mode display window 30, and a free-size mode display window 40 on the screen of the device. Further, the display windows 10, 20, 30, and 40 may be overlapped with each other and displayed, and a preset window from among the display windows 10, 20, 30, and 40 may be displayed depending on the type of the application. Further, the display unit 300 may display the key input window along with the display windows 10, 20, 30, and 40 on the screen.

Further, the display unit 300 may move the display window selected by the movement determination unit 200 on the screen. The display unit 300 may display the key input window on the screen, and may move the first display window corresponding to the key input window to a predetermined location and display the moved window. At this time, the first display window is a display window including a key input field in which letters inputted through the key input window are to be displayed, and may be a display window selected by the movement determination unit 200. Specifically, when the key input field of the first display window displayed in the screen is selected, the key input window corresponding to the selected key input field may be displayed on a part of the screen. Further, when the key input window is overlapped and displayed in the first display window, the display unit 300 may move the first display window. The display unit 300 may move the first display window so that the first display window is not overlapped with the key input window. Further, the display unit 300 may move the key input field so that the key input field of the first display window is not overlapped with the key input window. In this case, the display unit 300 may enlarge the key input field of the first display window to a predetermined size, and display the enlarged key input field.

Further, when the device is rotated, the display unit 300 may enlarge or reduce the moved display window. For example, when the mode of the screen of the device is changed from a vertical view (portrait) mode to a horizontal view (landscape) mode according to the rotation of the device, the display unit 300 may reduce the moved first display window and display the reduced window based on the distance between the key input window and the upper side of the screen.

Further, the display unit 300 may move a display window which does not include a key input field corresponding to the key input window. Specifically, when the key input window is displayed, the display unit 300 may move the pin-up display window 10 displayed on the screen. The display unit 300 may move the pin-up display window 10 so that the pin-up display window 10 is not overlapped with the key input window. The display unit 300 may control the pin-up display window 10 to be overlapped with the key input window and displayed, and the pin-up display window 10 to be displayed upper than the key input window.

Further, when the key input window is displayed, the display unit 300 may move a partial screen mode display window 300 which does not include the key input field in which letters are inputted by a key input through the key input window. In this case, the display unit 300 may move the second display window so that the second display window is not overlapped with the key input window.

Further, the display unit 300 may enlarge or reduce the size of at least one of the first display window, the pin-up display window 10 and the second display window, and move the enlarged or reduced window. Further, when moving a plurality of display windows, the display unit 300 may arrange a plurality of display windows and move the arranged windows. The arrangement may be automatically performed as a plurality of display windows are moved, but the present disclosure is not limited to this example. After the plurality of display windows are respectively moved to a predetermined location, the plurality of display windows may be arranged based on a separate user input. For example, when the user touches the screen of the device for a preset number of times using his fingers, a plurality of display windows may be arranged in a tiled manner.

Further, the display unit 300 may remove the displayed key input window from the screen, and return the moved display window to the original location. When the user input through the key input window is terminated, the display unit 300 may remove the key input window from the screen, and enlarge or reduce the size of the moved display window to a size of the display window before the movement. Further, the display unit 300 may move the moved display window to the location of the display window before the movement.

When the key input window is displayed in the screen of the device, the memory unit 400 stores various sets of information for moving a predetermined display window. The memory unit 400 may include information for selecting a display window to be moved, information for enlarging or reducing the selected display window, information for determining the movement location of the selected display window, and information for arranging the selected display window.

The controller 500 controls an overall operation of the device, and controls the input unit 100, the movement determination unit 200, the display unit 300 and the memory unit 400 so that the device moves a predetermined displayed window when the key input window is displayed on the screen of the device.

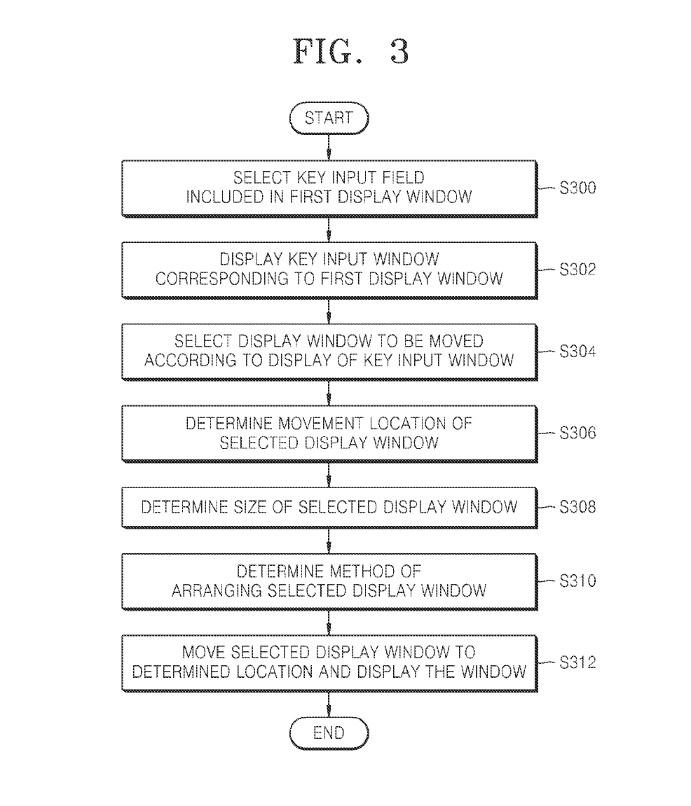

FIG. 3 is a detailed flowchart illustrating a method of moving a display window on a screen according to an embodiment of the present disclosure.

In operation S300, the device selects a key input field included in the first display window. In operation S300, the device may select a key input field included in the first display window based on the user's input. For example, the user may touch a key input field in the first display window displayed on the screen of the device, and the device may receive a user's input via the user's touch, and select a key input window touched according to the received user's input.

In operation S302, the device displays a key input window corresponding to the first display window. In operation S302, the device may display a key input window to input text in the key input field of the first display window. The key input window may be slid from at least one of the upper, lower, right and left sides of the screen of the device, and displayed on a part of the screen, but the present disclosure is not limited to this example.

In operation S304, the device selects a display window to be moved according to a display of the key input window. In operation S304, when the key input window is displayed on the screen of the device, the device may select a display window to be moved from among display windows displayed in the screen of the device. Further, when the key input field displayed in the display window is selected, the device may select a display window including the selected key input field as a display window to be moved.

Specifically, when the key input field included in the first display window is selected and the key input window is overlapped with part of the first display window and displayed on the screen of the device, the device may select the first display window as a display window to be moved. Further, when the key input window is overlapped with the key input field included in the first display window and displayed, the device may determine the first display window as a display window to be moved.

In operation S304, the device may select a second display window without the selected key input field along with the first display window. The second display window may be a display window without a key input field in which text input through the key input window is displayed. For example, the device may select a pin-up display window 10 without the selected key input field. Further, the device may select a partial screen mode display window 30 without the selected input field as a window to be moved.

In operation S306, the device determines the movement location of the selected display window. In operation S306, the device may determine the movement location of the selected display window so that all or part of the selected display window is not overlapped with the key input window. Further, the device may determine the movement location of the selected display window so that the key input field included in the selected display window is not overlapped with the key input window, but the present disclosure is not limited to this example.

In operation S308, the device determines the size of the selected display window. In operation S308, when the selected display window is moved, the device may determine the ratio by which the selected display window is enlarged or reduced. The device may determine the ratio of enlargement/reduction of the selected display window based on the size of a portion which is not covered by the key input window in the screen. For example, when the key input window is displayed in the lower part of the screen, the ratio of enlargement/reduction of the selected display window may be determined based on the distance between the upper part of the key input window and the upper part of the screen, but the present disclosure is not limited to this example.

In operation S310, the device determines a method of arranging the selected display window. In operation S310, the device may determine how to arrange a plurality of display windows after determining the plurality of display windows as display windows to be moved. In this case, the device may determine how to arrange the display window based on the size of the portion which is not covered by the key input window and the size of the display window to be moved. For example, the device may decide to reduce a plurality of display windows to a preset size, and arrange the reduced display windows in a tiled manner so as to be moved. Further, for example, when the first display window and the second display window are selected, the device may set the first display window to be located centered from the right and left sides of the screen, and the second display window to be arranged in the right and left sides of the screen.

In operation S312, the device moves the selected display window to a determined location and displays the moved window. In operation S312, the device may display the key input window in the screen and move the display window selected in operation S304. Further, the device may move the selected display window based on the movement location, size and arranged method determined in operations S306 to S310. An example of moving the selected display window by the device will be described in detail with reference to FIGS. 5 to 9.

FIG. 4 is a detailed flowchart illustrating a method of moving a display window moved when a key input window is removed according to an embodiment of the present disclosure.

In operation S400, the device removes the displayed key input window from the screen. In operation S400, when a user's input through the key input window is terminated, the device may remove the key input window from the screen.

In operation S402, the device returns the moved display window to the original location. In operation S402, the device may check the size and location before movement of the moved display window, enlarge or reduce the moved display window to a size of the window before the movement, and move the display window to a location of the window before the movement.

FIGS. 5 to 9 illustrate an example in which a display window is moved when a key input window is displayed according an embodiment of the present disclosure.

FIG. 5 illustrates an example of movement of a first display window according to an embodiment of the present disclosure.

Referring to the left part of FIG. 5, when the key input field 52 included in the first display window 50 is selected, the key input window 54 may be slid from the lower part of the screen so as to be displayed in part of the screen. Further, as shown in the left part of FIG. 5, when part of the first display window 50 is covered by the key input window 54, the device may move the first display window 50. Further, as shown in the right part of FIG. 5, the device may move the first display window 50 to a portion which is not covered by the key input window 54 in the screen of the device. In this case, the device may enlarge and move the first display window 50.

FIG. 6 illustrates an example of movement of a first display window according to another embodiment of the present disclosure.

Referring to the left part of FIG. 6, when the key input field 52 of the first display window 50 is covered by the key input window 54, the device may move the first display window 50. Further, as shown in the right part of FIG. 6, the device may move the first display window 50 so that the first display window 50 is overlapped with the key input window 54 and displayed, and the key input field 52 is not covered by the key input window 54. In this case, the device may enlarge or reduce the key input field 52 to a preset size, and display the key input field 52.

FIG. 7 illustrates an example of reduction and movement of a first display window according to an embodiment of the present disclosure.

As shown in FIG. 7, when part of the first display window 50 is covered by the key input window 54, the device may reduce and display the first display window 50. In this case, the device may determine the ratio of reduction of the first display window 50 based on a distance (d) between the upper part of the key input window 54 and the upper part of the screen.

FIG. 8 illustrates an example of movement of a first display movement along with another display window according to an embodiment of the present disclosure.

Referring to FIG. 8, when the key input field 52 included in the first display window 50 is selected, the key input window 54 may be slid from the bottom of the screen and displayed in part of the screen. Further, as shown in the left part of FIG. 8, part of the first display window 50 and the pin-up display window 56 may be covered by the key input window 54.

In this case, as shown in the right part of FIG. 8, the device may move the first display window 50 and the pin-up display window 56 to a portion which is not covered by the key input window 54 in the screen of the device. Further, the device may enlarge or reduce and move the first display window 50 and the pin-up display window 56.

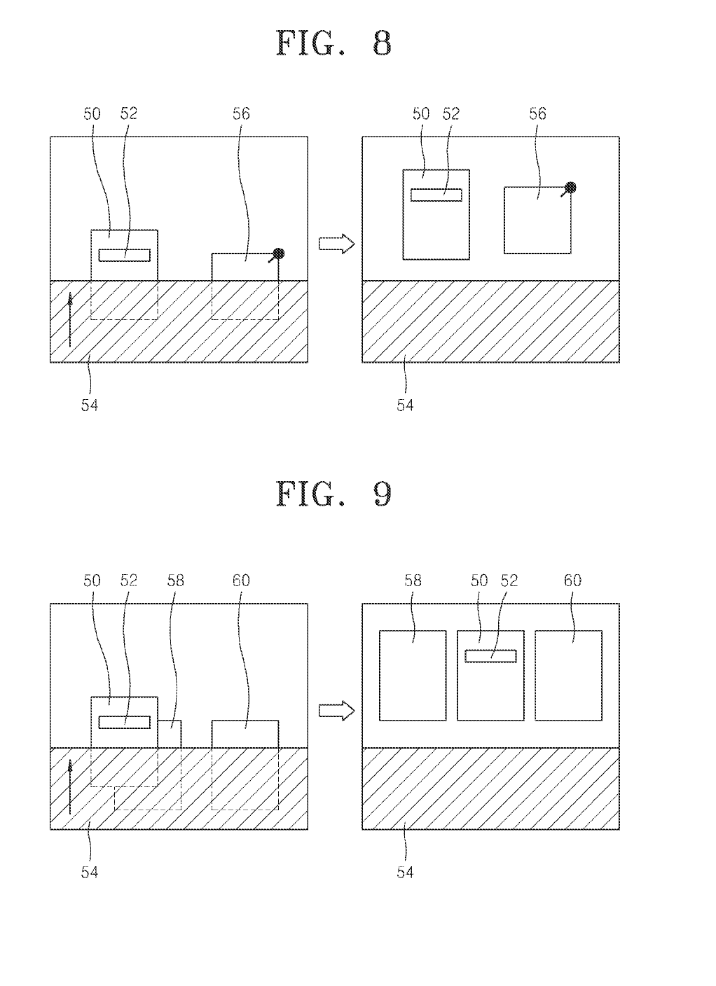

FIG. 9 illustrates an example of arrangement and movement of display windows other than the first display window according to another embodiment of the present disclosure.

As illustrated in FIG. 9, when the key input field 52 included in the first display window 50 is selected, the key input window 54 may be slid from the bottom of the screen and displayed in part of the screen. Further, as shown in the left part of FIG. 9, part of the first display window 50, the display window 58 and the display window 60 may be covered by the key input window 54. In this case, as shown in the right part of FIG. 9, the device may move the first display window 50, the display window 58 and the display window 60 to a portion which is not covered by the key input window 54 on the screen of the device. Further, the device may move the first display window 50 from the right or left part of the screen to the center of the screen, and arrange the display windows 58 and 60 to the right and left of the first display window 50. The arrangement may be automatically performed as the first display window 50, the display window 58 and the display window 60 are moved, but the present disclosure is not limited thereto. The first display window 50, the display window 58 and the display window 60 may be moved to a certain location, respectively, and then the first display window 50, the display window 58 and the display window 60 may be arranged based on a separate user's input. For example, when the user touches the screen of the device using some fingers for a preset number of times, the first display window 50, the display window 58 and the display window 60 may be arranged in a tiled manner.

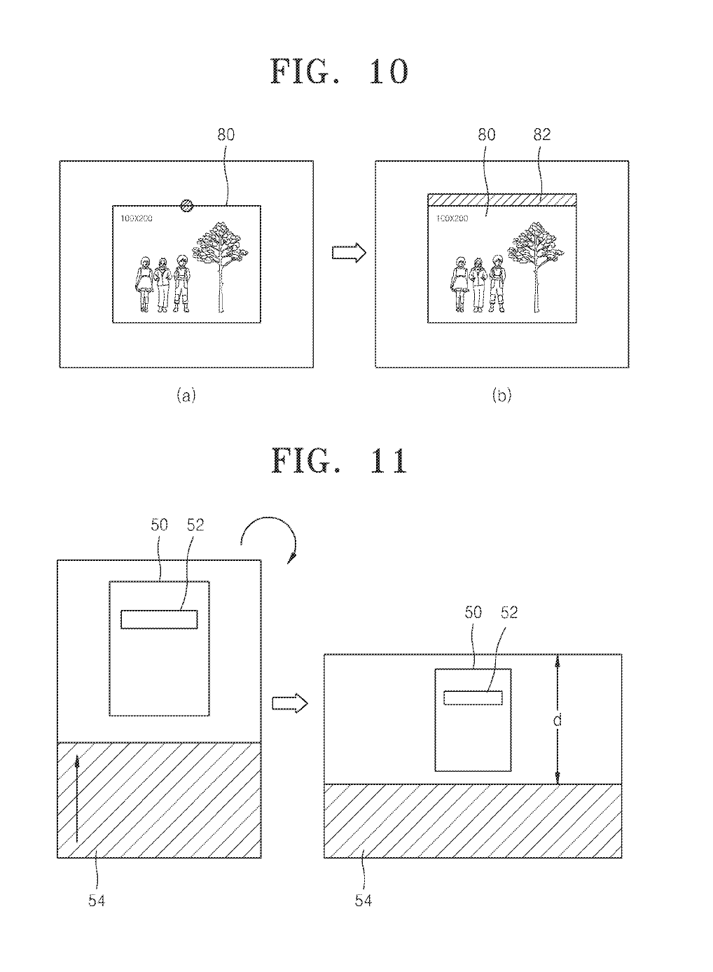

FIG. 10 illustrates an example in which the thickness of the border of a display window is changed and then the display window is displayed according to an embodiment of the present disclosure.

As illustrated in FIG. 10, when the user selects the border part of the upper end of the display window 80, the thickness of the upper side of the display window 80 may be displayed thick. Further, the user may change the location of the display window 80 on the screen by selecting and moving the thickened upper side 82 of the display window 80.

FIG. 11 illustrates an example in which a display window which has been moved according to a display of a key input window is reduced as a device is rotated according to an embodiment of the present disclosure.

As shown in the left part of FIG. 11, as the key input window 54 is displayed with the screen in a vertical (portrait) orientation, the first display window 50 may be moved to the upper side of the screen. As shown in the right part of FIG. 11, when the device is rotated in a horizontal direction (landscape orientation), and the distance (d) between the key input window 54 and the upper end of the screen is shortened, and the size of the first display window 50 may be reduced based on the distance d and be displayed.

According to the present disclosure, when a key input window for a key input is displayed on a screen, a display window overlapped with the key input window may be effectively moved.

Further, according to the present disclosure, a display window to be moved according to a display of a key input window may be selected from among a plurality of display windows on the screen, and the selected window may be changed, moved, and arranged at a desired location.

An embodiment of the present disclosure may be implemented in the form of a non-transitory computer readable storage medium including a program code executable by a computer. The non-transitory computer storage medium may be an arbitrary available medium accessible by a computer, and includes all volatile and non-volatile media and separable and non-separable media. The non-transitory computer storage medium includes all volatile and non-volatile media and separable and non-separable media, which have been implemented by an arbitrary method or technology, for storing information such as computer-readable commands, data structures, program modules, and other data. The communication medium typically includes a computer-readable command, a data structure, a program module, other data of a modulated data signal, and other transmission mechanisms, and also includes an arbitrary information transmission medium.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method of moving a display window on a screen, the method comprising:
displaying a key input window on a part of a screen; and
moving a first display window corresponding to the key input window as the key input window is displayed,
wherein the first display window is moved as the key input window overlaps at least part of the first display window.

2. The method of claim 1, wherein the key input window is displayed as a key input field of the first display window is selected, and
wherein the first display window is moved as the key input window overlaps at least part of the key input field.

3. The method of claim 1, wherein the first display window is moved to a portion of the screen where the key input window is not displayed.

4. The method of claim 3, wherein the first display window is moved such that a part of the first display window is covered by the key input window, and the key input field of the first display window is displayed in the portion of the screen where the key input window is not displayed, such that the key input window does not overlap the key input field.

5. The method of claim 4, wherein a size of the key input field is changed when the key input field of the first display window is selected.

6. The method of claim 3, wherein all of the first display window is moved to a portion of the screen where the key input window is not displayed on the screen, such that the key input window does not overlap the first display window.

7. The method of claim 6, further comprising:
changing a size of the first display window,
wherein the first display window with the changed sized is moved.

8. The method of claim 7, wherein the size of the first display window is reduced based on a distance between an interior edge of the key input window and an edge of the screen opposite an edge from which the key input window moved onto the screen.

9. The method of claim 1, further comprising:
determining a display window to be moved as the key input window is being displayed; and
moving the display window to be moved, which is set to be displayed in an area of the screen farthest from the key input window, along with the first display window.

10. The method of claim 1, further comprising:
determining a display window to be moved as the key input window is being displayed; and
moving a second display window having a size smaller than a preset size among a plurality of windows displayed on the screen.

11. The method of claim 10, wherein the first display window and the second display window are arranged and moved together.

12. The method of claim 1, further comprising:
removing the displayed key input window from the screen; and
moving the first display window to a location of the first display window before the movement as the key input window is removed.

13. A device configured to move a display window on a screen, the device comprising:
a display unit configured to display a key input window on a part of the screen; and
a movement location determination unit configured to determine a movement location of the first display window corresponding to the key input window as the key input window is displayed,
wherein the display unit moves the first display window based on the determined movement location, and moves the first display window as the key input window overlaps at least part of the first display window.

14. The device of claim 13, further comprising:
an input unit for receiving a user's input that selects a key input field of the first display window,
wherein the display unit displays the key input window as the key input field is selected, and moves the first display window as the key input window overlaps at least part of the key input field.

15. The device of claim 13, wherein the movement location determination unit determines a portion of the screen where the key input window is not displayed as the movement location of the first display window.

16. The device of claim 15, wherein the movement location determination unit determines the movement location so that a part of the first display window is covered by the key input window, and the key input field of the first display window is displayed in the portion of the screen where the key input window is not displayed on the screen, such that the key input window does not overlap the key input field.

17. The device of claim 16, wherein the display unit changes a size of the key input field as the key input field of the first display window is selected.

18. The device of claim 15, wherein the display unit moves all of the first display window to a portion of the screen where the key input window is not displayed.

19. The device of claim 18, wherein the display unit changes a size of the first display window and moves the first display window.

20. The device of claim 19, wherein the display unit reduces the size of the first display window based on a distance between an interior edge of the key input window and an edge of the screen opposite an edge from which the key input window moved onto the screen.

21. The device of claim 13, wherein the movement determination unit determines a display window, which is set to be displayed in a part of the screen farthest from the key input window, from among a plurality of windows displayed in the screen as a display window to be moved, and
wherein the display unit moves the determined display window along with the first display window as the key input window is being displayed.

22. The device of claim 13, wherein the movement determination unit determines a display window having a size smaller than a preset size among a plurality of windows displayed in the screen as a display window to be moved, and
wherein the display unit moves a second display window having a preset size or smaller than the present size as the key input window is displayed.

23. The device of claim 22, wherein the display unit arranges and moves the first display window and the second display window together.

24. The device of claim 13, wherein the display unit moves the displayed key input window from the screen, and moves the moved first display window to a location of the first display window before the movement.

25. A non-transitory computer-readable storage medium having recorded thereon a program for executing the method of claim 1 on a computer.

26. The method of claim 5, wherein the key input field is enlarged.

27. The method of claim 26, further comprising:
removing the displayed key input window from the screen; and
reducing the size of the key input field to a size before the movement as the key input window is removed.

28. The method of claim 8, further comprising:
removing the displayed key input window from the screen; and
enlarging the size of the first display window to a size before the movement as the key input window is removed.

29. The method of claim 9, wherein the display window to be moved comprises a display window pinned to be continually displayed.

30. The method of claim 9, further comprising:
centering the first display window in a part of the screen not overlapped by the key input window; and
arranging the display window to be moved at a side of the first display window.

31. The device of claim 17, wherein the key input field is enlarged.

32. The device of claim 31, wherein the displayed key input window is removed from the screen, and the size of the key input field is reduced to a size before the movement as the key input window is removed.

33. The device of claim 20, wherein the displayed key input window is removed from the screen, and the size of the first display window is enlarged to a size before the movement as the key input window is removed.

34. The device of claim 21, wherein the determined display window comprises a display window pinned to be continually displayed.

35. The device of claim 21, wherein the first display window is centered in a part of the screen not overlapped by the key input window, and the determined display window is arranged at a side of the first display window.
